(19) United States
(12) Patent Application Publication
(10) Pub. No.: US 2012/0102421 A1
(43) Pub. Date: Apr. 26, 2012

(54) METHODS AND APPARATUS FOR SPECIFYING AND APPLYING BUSINESS RULES IN A PRODUCT CONFIGURATOR

(75) Inventors: Timothy William Handorf, Trevor, WI (US); Prathibha Ramasubramanian, Deerfield, IL (US); Prashant Gupta, Deerfield, IL (US); Zakiya Sitembile Vallier, Chicago, IL (US); Swarvanu Sanyal, Chicago, IL (US)

(73) Assignee: BIGMACHINES, INC., Deerfield, IL (US)

(21) Appl. No.: 13/279,025

(22) Filed: Oct. 21, 2011

Related U.S. Application Data
(60) Provisional application No. 61/405,917, filed on Oct. 22, 2010.

(51) Int. Cl. G06F 3/048

(52) U.S. Cl. 715/771

(57) ABSTRACT

Methods and apparatus for specifying and applying businesses rules in a product configurator are disclosed. The disclosed system enables a design-time user to specify a set of businesses rules for a product configurator using a table. The system then converts this table to software instructions to enforce those business rules. A run-time user may then execute the software instructions to configure one or more products that conform to those rules.

### TECHNICAL FIELD

The present disclosure relates in general to product configuration, and, in particular, to methods and apparatus for specifying and applying businesses rules in a product configurator.

### BACKGROUND

Often, products have multiple options. However, those options may not all be compatible with each other. For example, a person may be selecting components for a new personal computer. If the user chooses a certain operating system for the computer, that operating system may require a certain minimum amount of memory and/or CPU speed. Configuration software may be used to assist the user and enforce these rules. However, present systems have certain drawbacks.

More specifically, current configuration systems require designers to individually specify each rule associated with the products by writing code with a text editor or via a point-and-click graphical user interface (GUI). For example, if three different operating systems are to be available to the customer purchasing the new personal computer, the designer may need to code an if-then statement for each operating system choice in order to enforce the required amount of memory for each operating system.

However, with multiple variables, this coding can quickly become very complex. For example, the operating system choice may affect things in the product configuration other than the memory, such as the CPU required to run that operating system. In addition, user choices other than the operating system may affect the memory and CPU requirements.

### SUMMARY

The presently disclosed system solves this problem using table-based rules. The disclosed system enables a first user at a client device (e.g., a designer at design-time) to specify a set of businesses rules for a product configurator using a table. For example, the table may specify a set of rules for configuring an automobile. The system then converts this table to software instructions to enforce those business rules. A second user (e.g., a customer at run-time) may then execute the software instructions to configure one or more products that conform to the rules. For example, a user at a web site may “build” his automobile.

### BRIEF DESCRIPTION OF THE DRAWINGS

FIG. 1 is a high level block diagram of an example communications system.

FIG. 2 is a more detailed block diagram showing one example of a computing device.

FIG. 3 is a flowchart of an example process to specify and apply businesses rules in a product configurator.

FIG. 4 is an example table for specifying businesses rules in a product configurator.

FIG. 5 is an example run-time display of a product configurator applying the businesses rules.

### DETAILED DESCRIPTION OF EXEMPLARY EMBODIMENTS

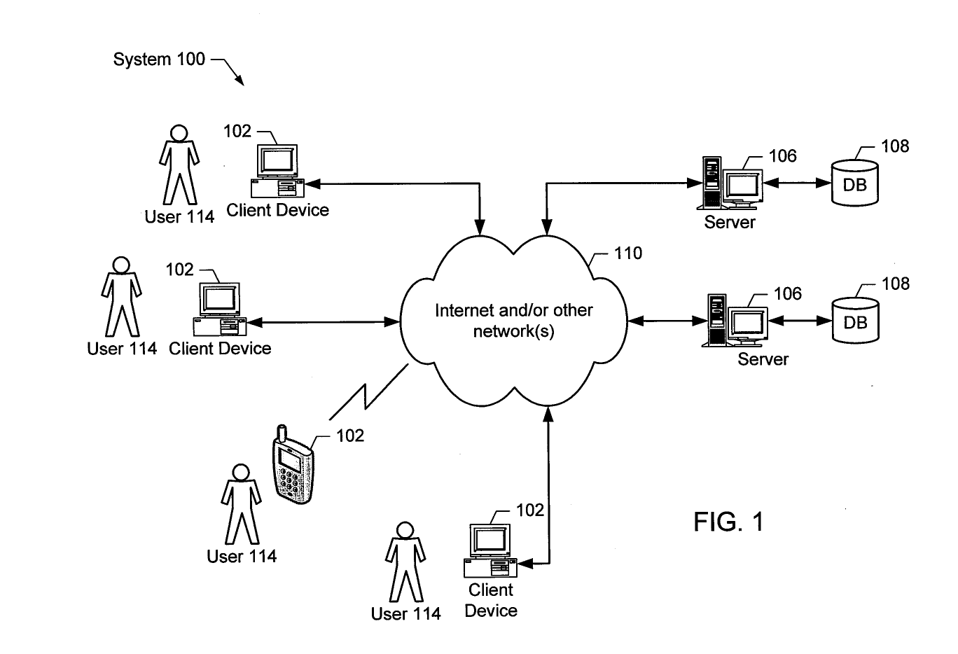

The present system is most readily realized in a network communications system. A high level block diagram of an exemplary network communications system 100 is illustrated in FIG. 1. The illustrated system 100 includes one or more client devices 102, one or more web servers 106, and one or more databases 108. Each of these devices may communicate with each other via a connection to one or more communications channels 110 such as the Internet or some other wired and/or wireless data network, including, but not limited to, any suitable wide area network or local area network. It will be appreciated that any of the devices described herein may be directly connected to each other instead of over a network.

The web server 106 stores a plurality of files, programs, and/or web pages in one or more databases 108 for use by the client devices 102 as described in detail below. The database 108 may be connected directly to the web server 106 and/or via one or more network connections. The database 108 stores data as described in detail below.

One web server 106 may interact with a large number of client devices 102. Accordingly, each server 106 is typically a high end computer with a large storage capacity, one or more fast microprocessors, and one or more high speed network connections. Conversely, relative to a typical server 106, each client device 102 typically includes less storage capacity, a single microprocessor, and a single network connection.

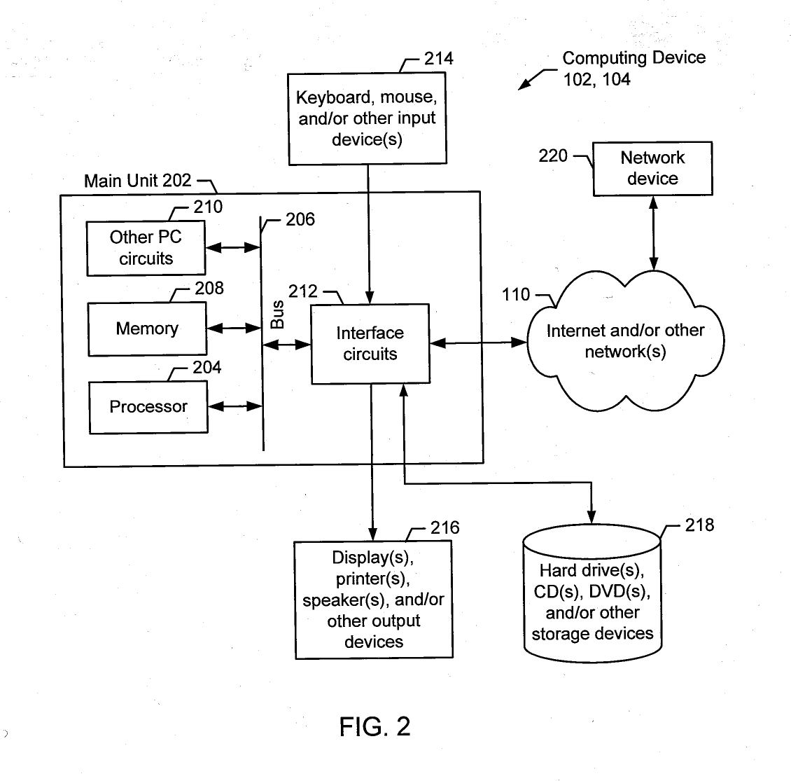

A more detailed block diagram of the electrical systems of a computing device (e.g., client device 102 and/or server 106) is illustrated in FIG. 2. Although the electrical systems of a client device 102 and a typical server 106 may be similar, the structural difference between the two types of devices are well known.

The client device 102 may include a personal computer (PC), a personal digital assistant (PDA), an Internet appliance, a cellular telephone, or any other suitable communication device. The client device 102 includes a main unit 202 which preferably includes one or more processors 204 electrically coupled by an address/data bus 206 to one or more memory devices 208, other computer circuitry 210, and one or more interface circuits 212. The processor 204 may be any suitable processor. The memory 208 preferably includes volatile memory and non-volatile memory. Preferably, the memory 208 stores a software program that interacts with the other devices in the system 100 as described below. This program may be executed by the processor 204 in any suitable manner. The memory 208 may also store digital data indicative of documents, files, programs, web pages, etc. retrieved from a server 106 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays, printers, speakers, and/or other output devices 216 may also be connected to the main unit 202 via the interface circuit 212. The display 216 may be a cathode ray tube (CRTs), liquid crystal displays (LCDs), or any other type of display. The display 216 generates visual displays of data generated during operation of the client device 102. For example, the display 216 may be used to display web pages and/or desktop pop-up data received from the server 106. The visual displays may include prompts for human input, run time statistics, calculated values, data, etc.

One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the client device 102.

The client device 102 may also exchange data with other network devices 220 via a connection to the network 110. The network connection may be any type of network connection, such as an Ethernet connection, digital subscriber line (DSL), telephone line, coaxial cable, etc. Users 114 of the system 100 may be required to register with the server 106. In such an instance, each user 114 may choose a user identifier (e.g., e-mail address) and a password which may be required for the activation of services. The user identifier and password may be passed across the network 110 using encryption built into the user's browser. Alternatively, the user identifier and/or password may be assigned by the server 106.

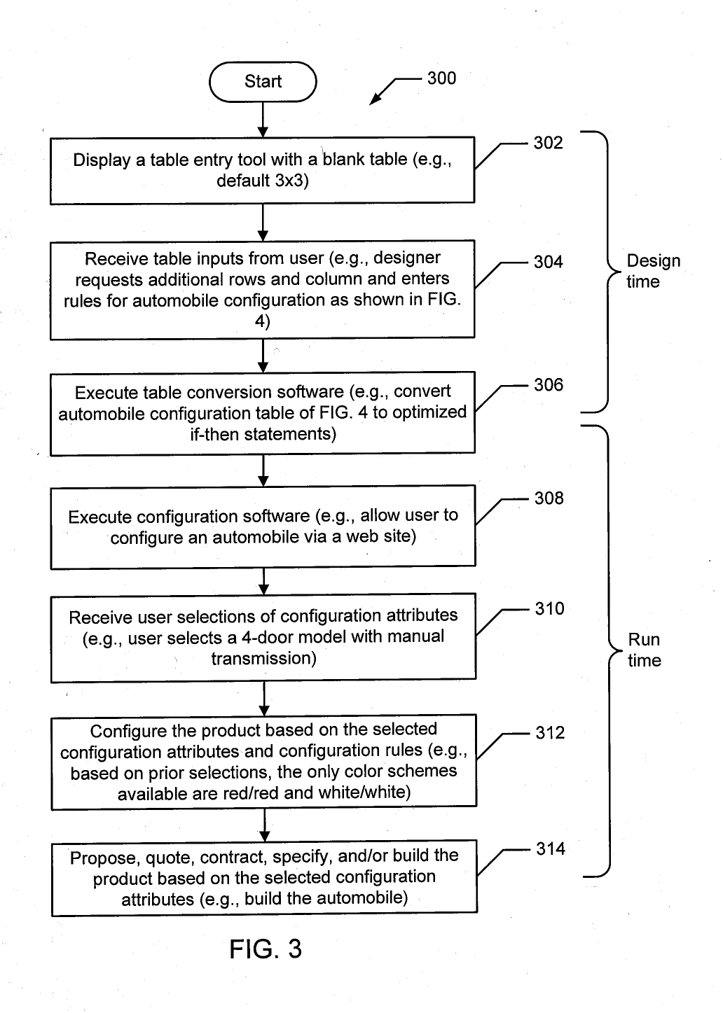

A flowchart of an example process 300 for specifying and applying businesses rules in a product configurator is illustrated in FIG. 3. Preferably, the process 300 is embodied in one or more software programs which is stored in one or more memories and executed by one or more processors. Although the process 300 is described with reference to the flowchart illustrated in FIG. 3, it will be appreciated that many other methods of performing the acts associated with process 300 may be used. For example, the order of many of the steps may be changed, and many of the steps described are optional.

In general, the process 300 enables a first user at a client device 102 (e.g., a designer at design-time) to specify a set of businesses rules for a product configurator using a table. For example, the table may specify a set of rules for configuring an automobile. The system then converts this table to software instructions to enforce those business rules. A second user (e.g., a customer at run-time) may then execute the software instructions to configure one or more products that conform to the rules. For example, a user at a web site may “build” his automobile.

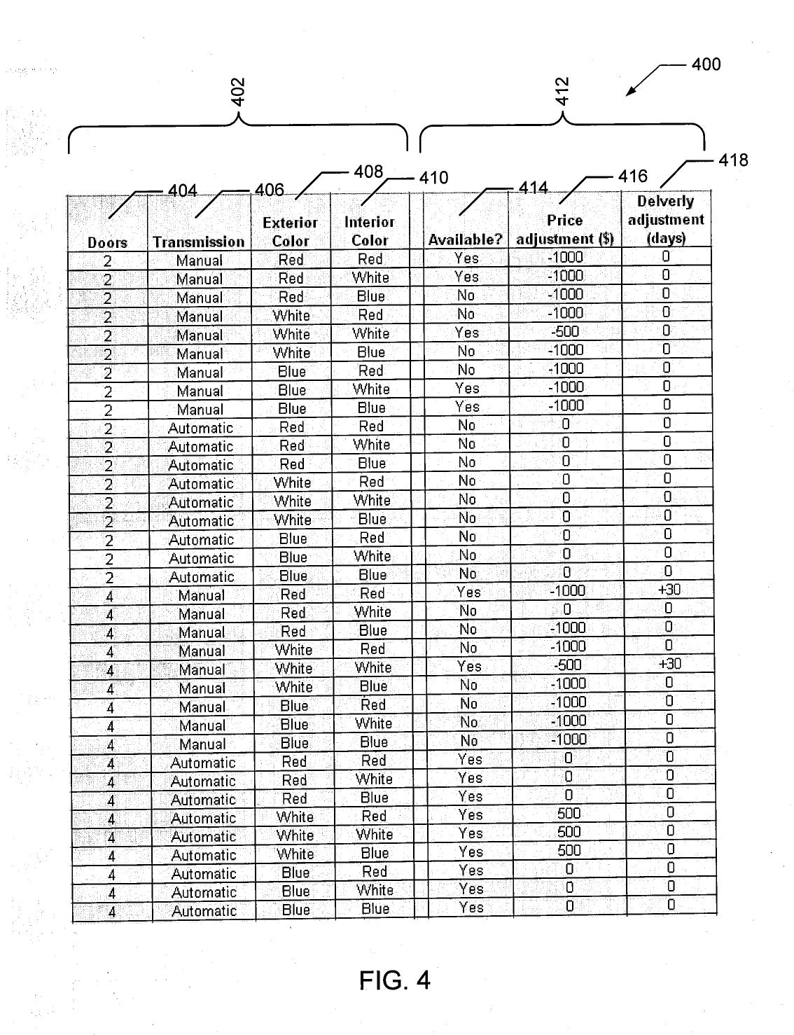

The process 300 preferably begins when a client device 102 displays a table entry tool with a blank table (block 302). For example, a table with a default number of rows and columns (e.g., 3×3) may be displayed. The design-time user may add and delete table columns and rows as needed. In addition the design-time user enters the business rules associated with the product configuration (block 304). For example, as shown in the example table 400 of FIG. 4, the user may specify a plurality of input attributes 402 associated with automobile configuration such as the number of doors 404, the type of transmission 406, the exterior color 408, the interior color 410. In addition, the user may specify a plurality of output attributes 412 associated with the input attributes 402 such as availability 414, price adjustments 416, and delivery adjustments 418.

The business rules entered in to the table may be any type of business rule. For example, the business rules may be bill of materials (BOM) rules, pricing rules, hiding, rules, recommendation rules, constraint rules, recommended items rules, etc.

For each configuration, where a products has a different set of parts, the user can create a bill of materials. When a BOM rule triggers, it appears to the end user (e.g., buyer) on a commerce document line item pages. End-users see multiple BOM's when several rules apply to a given configuration.

Pricing rules may be used to calculate a price based on how a product is configured. The designer can create a smart pricing system by generating business rules for configurable attributes that add cost to products. Pricing rules can be based on a combination of one or more configured values.

Hidden attribute rules tell the system to hide certain attributes when a pre-defined condition is met. Using hidden attribute rules, the designer can reduce the number of flow rules needed for a configuration process because the designer can include disparate attribute types in a single flow rule and how one set of attributes or another based on some condition.

Recommendation rules can be used to help end users configure products by offering suggested attributes values. For each configuration, where a model or part would likely have a certain attribute value, the designer can create a recommendation. When recommendations trigger, they preferably appear to end users. For example, the recommendation may display as text next to a configurable attribute that has a recommended value. For attributes with a set or forced option enabled, recommendation values automatically auto-populate the configurable attribute fields.

Constraint rules are set-up to warn an end user when a certain attribute value won't work in a configuration. These rules may be used to reduce errors in the configuration process. For example, if the end user is configuring an automobile and the end user selects a blue exterior color, a constraint may run that only allows the end user to select tan as an interior color. While a constraint is active, the system does not allow the end user to advanced to commerce.

Recommended item rules enable a designer to associate extra sets of parts and models with products based on user-configured values. If the recommended item is mandatory, then the end user must select (e.g. purchase) the configured model with the recommended item. Preferably, there is no way to delete the item association in the commerce process. If the item is not mandatory, then the end user can opt to not buy the recommended item.

Once the business rules are entered in to the table 400, the designer executes table conversion software to convert the table in to if-then statements (block 306). Alternatively, the user may cause the table conversion software to convert the table at run-time (block 306). For example, one if-then statement that may result from the example table of FIG. 4 is “If Doors=2 and Transmission=‘Automatic’ Then Available=‘No’. Another if-then statement that may result from the example table of FIG. 4 is “If Doors=4 and Transmission=‘Automatic’ and (ExteriorColor=‘Red’ or ExteriorColor=‘Blue’) Then PriceAdjustment=0. Preferably, the if-then statements are optimized.

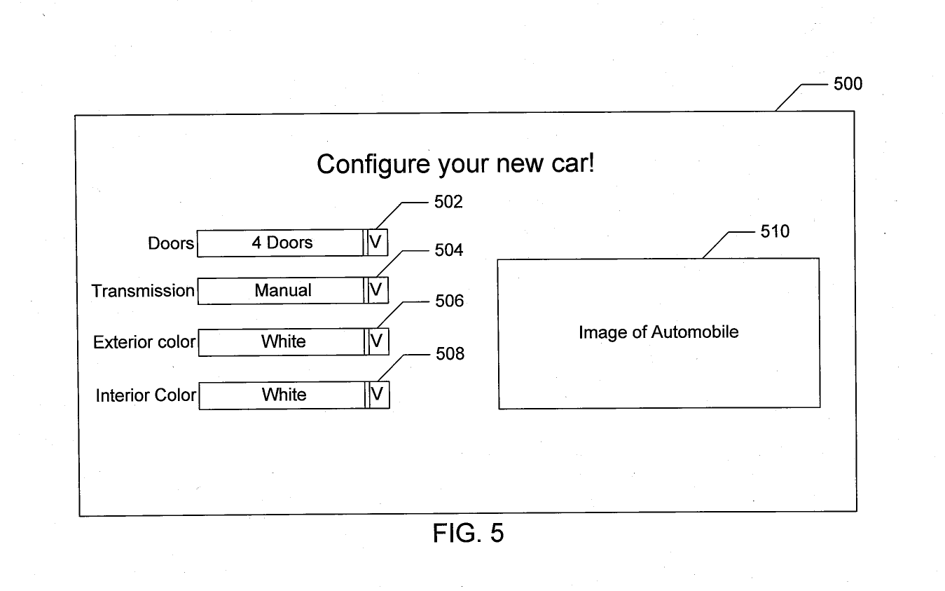

These if-then statements are then used when the configuration software is executed (block 308). For example, an end user may go to a web site 500 to configure an automobile (see FIG. 5). During the configuration the user enters a plurality of configuration attributes (block 310). For example, the user may select a 4-door model (via drop-down box 502) with a manual transmission (via drop-down box 504). It will be appreciated that any suitable input mechanism may be used such as check boxes, radio buttons, etc.

The product is interactively configured based on the selected configuration attributes and configuration rules (block 312). For example, if the user selected a 4-door model with a manual transmission, the only color schemes available, according to the example table in FIG. 4a and the corresponding if-then statements, are red exterior/red interior and white exterior/white interior. Accordingly, those are the only choices available for selection in the exterior color drop-down box 506 and the interior color drop-down box 508. Non-selectable choices (e.g., blue) may be excluded (e.g., not included in the drop-down box) or included (e.g., dimmed and not selectable).

If the user changes a choice in one drop-down box, the other drop-down boxes may also change based on business rules table and the corresponding if-then statements. For example, if the user changes from a 4-door automobile to a 2-door automobile, additional color scheme selections may become available (e.g., red/white, blue/white, and blue/blue). In another example, one attribute selection may require another attribute selection. For example, one automobile part may require another automobile part for installation. In such an instance, the configuration software preferably enforces this relationship for the user.

Once the user's selections are complete and the configuration rules are satisfied, a proposal, quote, contract, and/or specification associated with the product may be automatically generated, and/or the product may be built in accordance with the selected configuration parameters (block 314). For example, the automobile may built (or selected from inventory) and delivered to a dealer for purchase by the customer.

In summary, persons of ordinary skill in the art will readily appreciate that methods and apparatus for specifying and applying businesses rules in a product configurator have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

What is claimed is:

1. A computer implemented method of specifying and applying businesses rules in a product configurator, the method comprising:
displaying a table entry tool, wherein the table entry tool allows a first user to add and delete columns and rows;
receiving a plurality of business rules associated with a product configuration via the table entry tool;
executing first software to convert the plurality of business rules to logical statements; and
executing second software to allow a second user to interactively configure a product, the second software using the logical statements to assist the second user in configuring the product.

2. The method of claim 1, wherein the logical statements include if-then statements.

3. The method of claim 1, wherein the plurality of business rules includes a bill of materials rule.

4. The method of claim 1, wherein the plurality of business rules includes a pricing rule.

5. The method of claim 1, wherein the plurality of business rules includes a hidden attribute rule.

6. The method of claim 1, wherein the plurality of business rules includes a recommendation rule.

7. The method of claim 1, wherein the plurality of business rules includes a constraint rule.

8. The method of claim 1, wherein the plurality of business rules includes a recommended items rule.

9. The method of claim 1, wherein the first software is different than the second software.

10. The method of claim 1, wherein the first software is the same as the second software.

11. An apparatus for specifying and applying businesses rules in a product configurator, the apparatus comprising:
a processor;
an input device operatively coupled to the processor and a network;
an output device operatively coupled to the processor and the network; and
a memory device operatively coupled to the processor, the memory device storing a software application, the software application enabling:
the output device to display a table entry tool, wherein the table entry tool allows a first user to add and delete columns and rows;
the input device to receive a plurality of business rules associated with a product configuration via the table entry tool; and
the processor to execute software to convert the plurality of business rules to logical statements, wherein the logical statements are used by a second user to interactively configure a product.

12. The apparatus of claim 11, wherein the logical statements include if-then statements.

13. The apparatus of claim 11, wherein the plurality of business rules includes a bill of materials rule.

14. The apparatus of claim 11, wherein the plurality of business rules includes a pricing rule.

15. The apparatus of claim 11, wherein the plurality of business rules includes a hidden attribute rule.

16. The apparatus of claim 11, wherein the plurality of business rules includes a recommendation rule.

17. The apparatus of claim 11, wherein the plurality of business rules includes a constraint rule.

18. The apparatus of claim 11, wherein the plurality of business rules includes a recommended items rule.

19. A computer readable memory storing a software application, the software application enabling:
an output device to display a table entry tool, wherein the table entry tool allows a first user to add and delete columns and rows;
an input device to receive a plurality of business rules associated with a product configuration via the table entry tool; and
a processor to execute software to convert the plurality of business rules to logical statements, wherein the logical statements are used by a second user to interactively configure a product.

20. The computer readable memory of claim 19, wherein the logical statements include if-then statements.

21. The computer readable memory of claim 19, wherein the plurality of business rules includes a bill of materials rule.

22. The computer readable memory of claim 19, wherein the plurality of business rules includes a pricing rule.

23. The computer readable memory of claim 19, wherein the plurality of business rules includes a hidden attribute rule.

24. The computer readable memory of claim 19, wherein the plurality of business rules includes a recommendation rule.

25. The computer readable memory of claim 19, wherein the plurality of business rules includes a constraint rule.

26. The computer readable memory of claim 19, wherein the plurality of business rules includes a recommended items rule.
